(19) United States
(12) Patent Application Publication
(10) Pub. No.: US 2020/0244824 A1
(43) Pub. Date: Jul. 30, 2020

(54) IMAGE FORMING APPARATUS, IMAGE FORMING SYSTEM, AND CONTROLLING METHOD OF THE IMAGE FORMING APPARATUS

(71) Applicant: KONICA MINOLTA, INC., Tokyo (JP)

(72) Inventor: Tatsuya KAWANO, Tokyo (JP)

(73) Assignee: KONICA MINOLTA, INC., Tokyo (JP)

(21) Appl. No.: 16/745,731

(22) Filed: Jan. 17, 2020

(30) Foreign Application Priority Data
Jan. 29, 2019 (JP) 2019-013294

(51) Int. Cl. H04N 1/00; G10L 25/60; G10L 15/32; G10L 15/22; G10L 25/24; G10L 15/08

(52) U.S. Cl. CPC H04N 1/00403; G10L 25/60; H04N 1/00307; G10L 15/32; G10L 15/22; G10L 2015/088; H04N 2201/0075; G10L 25/24; G10L 15/08; G10L 2015/223; H04N 2201/0094

(57) ABSTRACT

An image forming apparatus that can reduce an information leak risk is provided. Configured is the image forming apparatus including a first voice input unit, a communication unit that receives a second voice signal from a second voice input unit that collects a sound around a portable terminal, a first voice recognition unit that recognizes voice operation start voice on the basis of the input of the first voice input unit, a selection unit that selects the first voice input unit or the second voice input unit, an input switching unit that enables the voice input by the selected first voice input unit or the selected second voice input unit, and a second voice recognition unit that recognizes the content of a voice operation instruction on the basis of the input of the voice signal from the first voice input unit or the second voice input unit.

### CROSS-REFERENCE TO RELATED APPLICATIONS

The entire disclosure of Japanese Patent Application Nos. 2019-13294, filed on Jan. 29, 2019 and 2019-13295, filed on Jan. 29, 2019, is incorporated herein by reference in its entirety.

### BACKGROUND

### Technological Field

The present invention relates to an image forming apparatus, an image forming system, and a controlling method of the image forming apparatus, which enable an operation by voice input.

### Description of the Related Art

An image forming apparatus that can be operated, not only by a conventional operation panel, but also by voice, has appeared. In such an image forming apparatus, a microphone for the voice operation (hereinafter, a mike) is incorporated in the main body of the image forming apparatus, or is installed near the image forming apparatus. Thus, a user can operate the image forming apparatus by voice by uttering a voice operation instruction toward the image forming apparatus.

For example, an image processing system is proposed that communicates with a mike connected to an image forming apparatus and a mike of a portable terminal disposed outside the image forming apparatus (for example, see Patent Literature 1 (Japanese Unexamined Patent Application Publication No. 2014-203024)). In this image forming system, when the input of a first voice signal is received from the mike connected to the image forming apparatus and then, voice recognition on the basis of the first voice signal is unsuccessful, the input of a second voice signal is received from the mike connected to the portable terminal. In this way, when the input of the first voice signal is unsuccessful, the voice recognition on the basis of the second voice signal is executed, so that the accuracy of the instruction by voice can be easily improved.

Also, an image forming system is proposed in which when in a voice operation instruction with respect to an image forming apparatus that can communicate with an external server and the like, a secret word, such as personal information and confidential information, is included in the voice uttered by a user, the voice data of the secret word is replaced with the voice data of a replacing word to generate data (for example, see Patent Literature 2 (Japanese Unexamined Patent Application Publication No. 2015-88890)). With this, when secret information is included in voice inputted to the image forming apparatus, the secret information can be prevented from being leaked in the communication with the outside.

### CITATION LIST

### Patent Literature

Patent Literature 1: Japanese Unexamined Patent Application Publication No. 2014-203024

Patent Literature 2: Japanese Unexamined Patent Application Publication No. 2015-88890

### SUMMARY

However, since the image forming apparatus is typically installed in an office and the like, it is assumed that there are many people around the image forming apparatus. Consequently, when the voice including personal information, confidential information, and the like is included in the voice operation instruction uttered by the user, a risk in which the information is leaked from the voice is a concern.

To solve at least one of the above problems, the present invention provides an image forming apparatus, an image forming system, and a controlling method of the image forming apparatus, which can reduce an information leak risk.

An image forming apparatus according to an aspect of the present invention comprises a first voice input unit that collects a sound around the image forming apparatus to generate a first voice signal, a communication unit that receives, from a portable terminal, a second voice signal generated by a second voice input unit that collects a sound around the portable terminal, a first voice recognition unit that recognizes voice operation start voice meaning the start of a voice operation instruction on the basis of the input of the first voice signal of the first voice input unit, a selection unit that selects the voice input unit from the first voice input unit and the second voice input unit of the portable terminal on the basis of the comparison result of the recognition result of the first voice recognition unit and previously set information, an input switching unit that switches and enables the voice input from the first voice input unit or the second voice input unit selected by the selection unit, and a second voice recognition unit that recognizes the content of the voice operation instruction on the basis of the first voice signal inputted from the first voice input unit in which the input switching unit enables the voice input or the second voice signal inputted from the second voice input unit in which the input switching unit enables the voice input.

Also, an image forming system according to an aspect of the present invention comprises an image forming apparatus and an external server that can communicate with the image forming apparatus. This image forming system comprises a first voice input unit that collects a sound around the image forming apparatus to generate a first voice signal, a communication unit that receives, from a portable terminal, a second voice signal generated by a second voice input unit that collects a sound around the portable terminal, a first voice recognition unit that recognizes voice operation start voice meaning the start of a voice operation instruction on the basis of the input of the first voice signal of the first voice input unit, a selection unit that selects the voice input unit from the first voice input unit and the second voice input unit of the portable terminal on the basis of the comparison result of the recognition result of the first voice recognition unit and previously set information, an input switching unit that switches and enables the voice input from the first voice input unit or the second voice input unit selected by the selection unit, and a second voice recognition unit that recognizes the content of the voice operation instruction on the basis of the first voice signal inputted from the first voice input unit in which the input switching unit enables the voice input or the second voice signal inputted from the second voice input unit in which the input switching unit enables the voice input. And, the first voice input unit, the communication unit, and the input switching unit are disposed in the image forming apparatus, and each of the first voice recognition unit, the selection unit, and the second voice recognition unit is disposed in at least one of the image forming apparatus and the external server.

Also, a controlling method of an image forming apparatus according to an aspect of the present invention comprises, in a first voice input unit, collecting a sound around the image forming apparatus to generate a first voice signal, in a communication unit, receiving, from a portable terminal, a second voice signal on the basis of a sound around the portable terminal collected by a second voice input unit of the portable terminal, in a first voice recognition unit, recognizing voice operation start voice meaning the start of a voice operation instruction on the basis of the first voice signal inputted from the first voice input unit, in a selection unit, selecting the voice input unit from the first voice input unit and the second voice input unit of the portable terminal on the basis of the comparison result of the recognition result of the first voice recognition unit and previously set information, in an input switching unit, enabling the voice input from the first voice input unit or the second voice input unit selected by the selection unit, and in a second voice recognition unit, recognizing the content of the voice operation instruction with respect to the image forming apparatus on the basis of the first voice signal inputted from the first voice input unit in which the input switching unit enables the voice input or the second voice signal inputted from the second voice input unit in which the input switching unit enables the voice input.

### BRIEF DESCRIPTION OF THE DRAWINGS

The advantages and features provided by embodiments of the invention will become more fully understood from the detailed description given hereinbelow and the appended drawings which are given by way of illustration only, and thus are not intended as a definition of the limits of the present invention:

FIG. 1 is a diagram illustrating the schematic configuration of an image forming system;

FIG. 2 is a diagram illustrating the hardware configuration example of an image forming apparatus;

FIG. 3 is a diagram illustrating the hardware configuration example of a portable terminal;

FIG. 4 is a diagram illustrating the system control configuration related to the voice operation of the image forming apparatus;

FIG. 5 is a diagram illustrating the operation flowchart of the voice operation of the image forming system;

FIG. 6 is the flowchart of an input switching process in the voice operation of the image forming system;

and

FIG. 7 is a diagram illustrating the system control configuration related to the voice operation of an image forming system.

### DETAILED DESCRIPTION OF EMBODIMENTS

Embodiments of the present invention will be described below with reference to the drawings, but the scope of the present invention is not limited to the following embodiments.

It should be noted that the embodiments will be described in the following order.

1. The embodiment of an image forming system (First Embodiment)
2. The embodiment of an image forming system (Second Embodiment)

### 1. The Embodiment of an Image Forming System (First Embodiment)

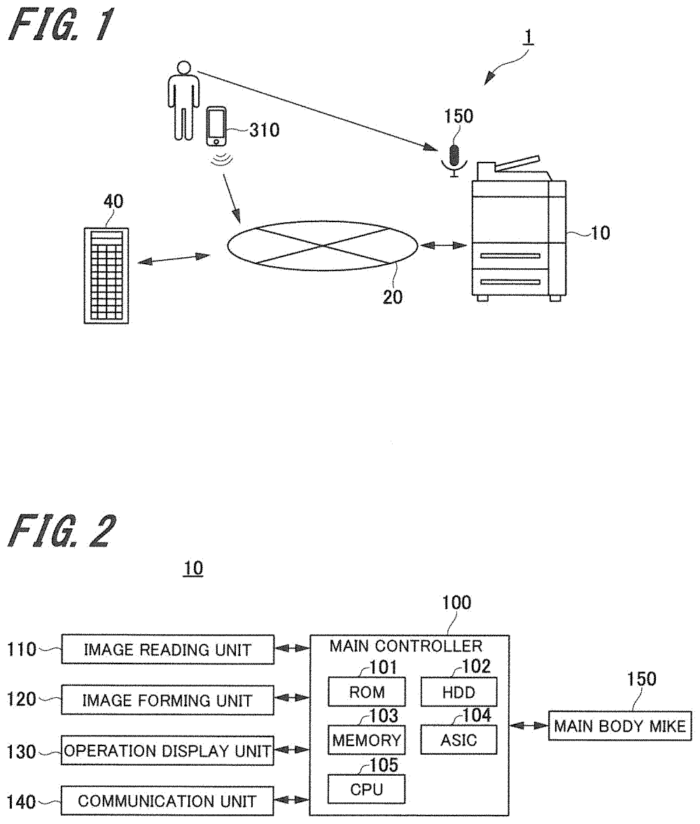

The specific embodiment of an image forming system will be described below. FIG. 1 illustrates the schematic block diagram of the image forming system of the present embodiment.

An image forming system 1 illustrated in FIG. 1 includes an image forming apparatus 10, and a main body mike 150 as the configuration of a first voice input unit in which the image forming apparatus 10 receives voice input. The image forming apparatus 10 is connected to a network 20, such as a LAN (Local Area Network). And, the image forming apparatus 10 is connected via the network 20 to a portable terminal 310 including a second voice input unit used by a user. Further, the image forming apparatus 10 may include an external server 40 and the like via the network 20.

The network 20 may be wired or wireless. For example, an example is given in which the image forming apparatus 10 and the external server 40 are connected via the wired LAN and the image forming apparatus 10 and the portable terminal 310 are connected via the wireless LAN.

The image forming apparatus 10 has a configuration for achieving an image forming function. The main body mike 150 as the first voice input unit is not necessarily required to be included in the image forming apparatus 10. Further, the first voice input unit that receives voice input is not limited to the main body mike 150, and may also include a processing device that processes a voice signal inputted from a voice input device connected thereto.

The portable terminal 310 includes a portable terminal, such as a mobile phone and a smartphone. The portable terminal 310 includes a mike, as the second voice input unit, achieving a function for receiving voice input, a display unit, such as a touch panel, for displaying (outputting) information, and a voice output unit, such as a speaker. It should be noted that in the image forming system 1, the portable terminal 310 is not particularly limited as long as it has at least these functions and can be carried by the user.

### The Hardware Configuration of the Image Forming Apparatus

FIG. 2 illustrates the specific example of the hardware configuration of the image forming apparatus 10 related to the image forming system 1. It should be noted that the image forming apparatus 10 illustrated here represents a typical apparatus configuration including an image reading function and a printing function, but is not necessarily required to be equipped with all the functions, and may be configured to have the limitative functions of a facsimile device, a scanner device, and the like.

The image forming apparatus 10 is configured such that a main controller 100, an image reading unit 110, an image forming unit 120, an operation display unit 130, a communication unit 140, and the main body mike 150 are mutually connected.

The main controller 100 includes elements necessary for the typical image forming apparatus, such as a CPU (Central Processing Unit) 105 that is a calculation device that functions as a control device, a ROM (Read Only Memory) 101 that stores a program and the like executed by the CPU 105, an HDD (hard disk drive) 102 that stores image data and the like, a memory 103 that functions as a working region when the program is executed by the CPU 105, and an ASIC (application specific integrated circuit) 104 that is equipped with each circuit necessary for controlling the image forming apparatus 10.

The image forming apparatus 10 executes the image reading function (scan), the image forming function (printing), and the like on the basis of an operation instruction from the operation display unit 130 and the communication unit 140. Also, when the user inputs voice including a particular operation instruction to the main body mike 150, the image forming apparatus 10 performs a voice recognition process in the main controller 100, and executes various functions according to the content of the voice operation instruction, like the operation instruction from the operation display unit 130 and the communication unit 140.

It should be noted that the configuration of the image forming apparatus 10 illustrated in FIG. 2 adopts the form in which the main body mike 150 is connected to the main controller 100 via an I/F, not illustrated, but the connection of the main body mike 150 and the main controller 100 is not limited to this form. For example, the main body mike 150 may be equipped therein with a control unit that performs the voice recognition process to be configured to perform therein part of the voice recognition process (for example, the recognition process of voice operation start voice) and to connect the control unit and the main controller 100. Further, the image forming apparatus 10 may have a form of executing the communication between the main body mike 150 and the main controller 100 via the network, such as a LAN (Local Area Network) and a WAN (Wide Area Network).

The image reading unit 110 optically reads a document placed on a document platen, not illustrated, to obtain image data. The image forming unit 120 performs image formation in which an image is printed on a sheet. The operation display unit 130 includes an input unit including operation keys, not illustrated, and a display unit including a touch panel, not illustrated. For example, the operation display unit 130 is configured such that a display device, such as a liquid crystal display device, and a position instruction device of the touch panel that is of the optical type, the electrostatic capacity type, and the like are overlapped, and an operation screen is displayed on the display device to identify the instruction position on the operation screen. The CPU 105 allows the display device to display the operation screen on the basis of previously stored data for allowing image display. The identified instruction position (the touched position) on the display device and the operation signal indicating the depressed key are inputted to the CPU 105. The CPU 105 identifies the operation content from the depressed key or the operation screen and the instruction position that are being displayed, and executes the process on the basis of the operation content. The communication unit 140 performs communication via the network 20.

### The Configuration of the Portable Terminal

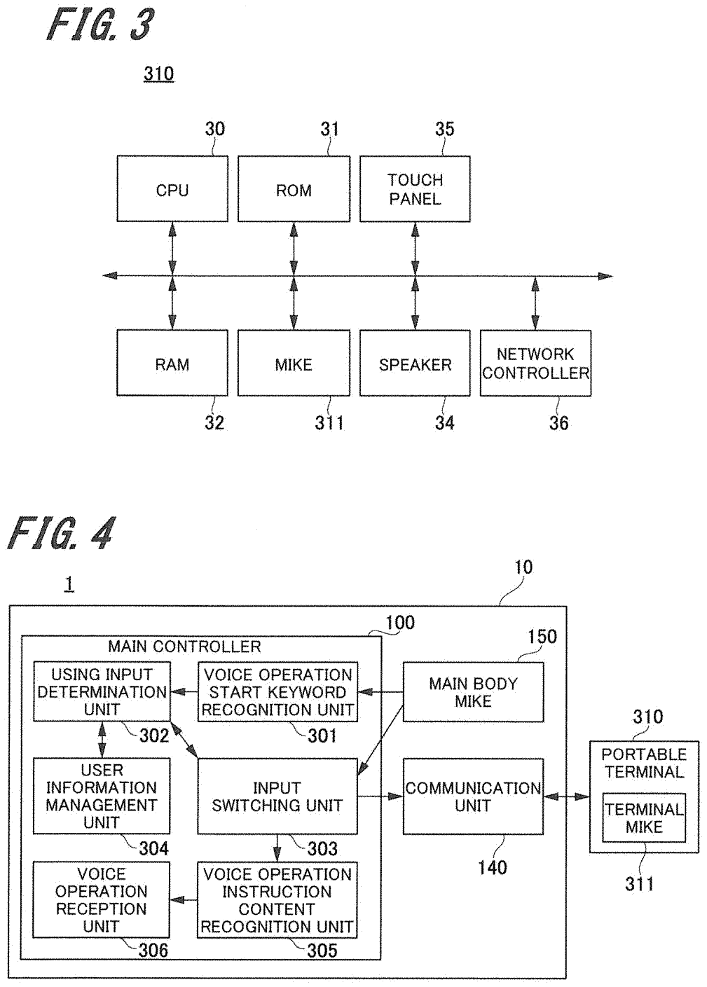

FIG. 3 illustrates the specific example of the hardware configuration of the portable terminal 310. As illustrated in FIG. 3, the portable terminal 310 includes a CPU 30 that is a calculation device controlling the entire portable terminal 310, a ROM 31 that stores a program and the like executed by the CPU 30, a RAM 32 that functions as a working region when the program is executed by the CPU 30, a terminal mike 311 that functions as the second voice input unit, a speaker 34, a touch panel 35 that functions as an operation display unit, and a network controller 36 to control communication via the network 20. When having the telephone function of a mobile phone, a smartphone, and the like, as described above, the portable terminal 310 further includes a configuration for achieving the telephone function.

### The System Control Configuration of the Image Forming System

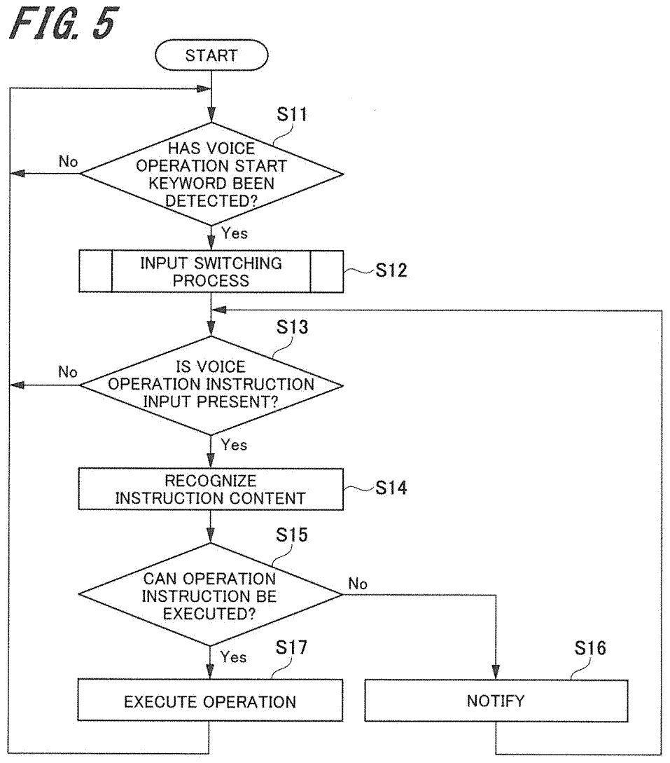

FIG. 4 illustrates the system control configuration related to the voice operation of the image forming apparatus 10 in the image forming system 1.

In the image forming system 1, the main body mike 150 that is the first voice input unit and the main controller 100 mounted in the image forming apparatus 10 communicate with each other. Also, via the communication unit 140, the main controller 100 and the external portable terminal 310 communicate with each other via the network 20 (see FIG. 1).

The main controller 100 includes a voice operation start keyword recognition unit 301 that is a first voice recognition unit, a using input determination unit 302 that is a selection unit for selecting the voice input unit and identifying the portable terminal 310, an input switching unit 303, a user information management unit 304 that manages user information related to the user, a voice operation instruction content recognition unit 305 that is a second voice recognition unit, and a voice operation reception unit 306.

The portable terminal 310 includes the terminal mike 311 that is the second voice input unit mounted in the portable terminal 310. The portable terminal 310 is communicatively connected via the network 20 to the communication unit 140 of the image forming apparatus 10. The portable terminal 310 transmits, as a second voice signal (voice data), a sound around the portable terminal 310 collected by the terminal mike 311 via the communication unit 140 to the main controller 100.

The main body mike 150 collects a sound around the image forming apparatus 10, and obtains voice uttered by the user around the image forming apparatus 10. And, a first voice signal (voice data) obtained by the main body mike 150 is transmitted to the voice operation start keyword recognition unit 301 and the input switching unit 303.

The voice operation start keyword recognition unit 301 recognizes a keyword meaning the start of the voice operation (a voice operation start keyword) from the first voice signal. When having recognized the keyword from the first voice signal, the voice operation start keyword recognition unit 301 transmits the first voice signal including the voice operation start keyword to the using input determination unit 302.

The using input determination unit 302 extracts, from the first voice signal, characteristic data decided on the basis of the voice quality of the user. And, the using input determination unit 302 compares the extracted characteristic data and the characteristic data of each user stored in the user information management unit 304. By this comparison, the using input determination unit 302 identifies the user who utters the voice to the main body mike 150.

The user information management unit 304 has, as the user information related to the user, the characteristic data of the user, connection information of the portable terminal 310 owned by the user, user setting information including the presence or absence of the use of the portable terminal 310 and the like, and the like. The characteristic data of the user that the user information management unit 304 has may be of any form as long as it is information that can be used for identifying the user (speaker). As an example, the characteristic amounts widely used by the speaker recognition, an LPC cepstrum coefficient (LPCC) and a mel frequency cepstrum coefficient (MFCC) are given. When the user information is registered to the user information management unit 304, these characteristic amounts are calculated, and are stored, as the characteristic data of the user, so as to be associated with the user information, so that the user comparison is enabled.

The using input determination unit 302 reads the user information related to the identified user from the user information management unit 304, and identifies the portable terminal 310 to be connected, from the connection information of the portable terminal 310 associated with the user information. And, the using input determination unit 302 instructs the input switching unit 303 to enable the connection with the identified portable terminal 310. The input switching unit 303 switches the communication from the main body mike 150 to the portable terminal 310 identified by the using input determination unit 302, and enables the communication with the portable terminal 310. With this, the using input determination unit 302 enables the input of the voice signal (the second voice signal) from the terminal mike 311 incorporated in the portable terminal 310.

It should be noted that the using input determination unit 302 may perform the switching of the communication by the input switching unit 303 on the basis of the user setting information stored in the user information management unit 304. For example, when the user setting information includes setting in which the portable terminal is used for voice input, the using input determination unit 302 switches the input switching unit 303 to enable the communication with the portable terminal 310. Also, when the user setting information does not include setting in which the portable terminal is used for voice input, the using input determination unit 302 enables voice input from the main body mike 150 without performing the switching by the input switching unit 303.

After the input switching unit 303 enables the voice input from the portable terminal 310, the voice input from the user is performed from the terminal mike 311. Thus, when the user voice inputs the voice operation start keyword to the main body mike 150, and then utters the voice operation instruction to the portable terminal 310, the second voice signal (voice data) is transmitted to the voice operation instruction content recognition unit 305 via the terminal mike 311, the communication unit 140, and the input switching unit 303.

The voice operation instruction content recognition unit 305 recognizes the voice of the operation instruction with respect to the image forming apparatus 10 from the second voice signal transmitted from the portable terminal 310. And, the voice operation instruction content recognition unit 305 notifies the recognized operation instruction content to the voice operation reception unit 306. The voice operation reception unit 306 instructs the image forming apparatus 10 to execute the predetermined process according to the operation instruction content notified from the voice operation instruction content recognition unit 305.

It should be noted that when the using input determination unit 302 cannot identify the portable terminal 310 on the basis of the user information, the input switching unit 303 may maintain the communication with the main body mike 150. In this case, the voice operation instruction content recognition unit 305 recognizes the content of the voice operation instruction according to the voice input from the main body mike 150, and the voice operation reception unit 306 instructs the image forming apparatus 10 to execute the predetermined operation according to the voice operation instruction.

### The Operation Flow of the Image Forming System

FIG. 5 illustrates the operation flowchart of the voice operation of the image forming system.

First, when the voice of the user is inputted from the main body mike 150, the image forming apparatus 10 determines whether or not the voice operation start keyword recognition unit 301 has detected the operation start keyword (step S11). For example, the user performs instruction with respect to the image forming apparatus 10 by voice by using the operation start keyword, such as “start copy”, and the voice operation start keyword recognition unit 301 detects this operation start keyword from the inputted voice.

When the voice operation start keyword recognition unit 301 has not detected the operation start keyword from the voice inputted by the user (No in step S11), the determination with respect to the voice inputted is repeated until the operation start keyword is detected.

When the voice operation start keyword recognition unit 301 has detected the operation start keyword (Yes in step S11), the input switching unit 303 performs the switching process for the voice input unit that enables the voice input (step S12). The input switching unit 303 performs the process for switching the voice input unit that enables the input of the voice operation by the input switching process, to the main body mike 150 (the first voice input unit) or the terminal mike 311 (the second voice input unit) of the portable terminal 310 associated with the user information. The detail of the input switching process in the input switching unit 303 will be described later.

After the input switching process, the voice operation instruction content recognition unit 305 determines whether a voice operation instruction is included in the voice signal inputted from the selected voice input unit (step S13).

When having detected the voice operation instruction from the voice signal (Yes in step S13), the voice operation instruction content recognition unit 305 recognizes the instruction content included in the voice signal (step S14).

When the voice operation instruction content recognition unit 305 has not detected the voice operation instruction from the voice signal (No in step S13), the detection of the voice operation instruction is stopped. For example, when a predetermined time has elapsed without detecting the voice operation instruction after the input switching process, the detection of the voice operation instruction is stopped. Also, when the voice input from the terminal mike 311 of the portable terminal 310 is enabled by the input switching process, the input switching unit 303 may switch the voice input unit from the portable terminal 310 side to the main body mike 150. And, after the detection of the voice operation instruction is stopped, the process for detecting the operation start keyword by the voice operation start keyword recognition unit 301 (step S11) is repeated again.

The voice operation instruction content recognition unit 305 determines whether the recognized operation instruction content can be executed in the image forming apparatus 10 (step S15). When the operation instruction content cannot be executed (No in step S15), the voice operation instruction content recognition unit 305 uses the display on the operation display unit of the image forming apparatus 10 and the voice from the portable terminal 310 to notify that the instructed operation content cannot be executed in the image forming apparatus 10 with respect to the user (step S16). And, until the voice operation instruction from the user is inputted after the notification, the determination whether the voice operation instruction is included in the voice signal inputted from the selected voice input unit (step S13) is performed again.

When the operation instruction content can be executed (Yes in step S15), the voice operation instruction content recognition unit 305 notifies the instruction content to the voice operation reception unit 306. And, the voice operation reception unit 306 instructs the image forming apparatus 10 to execute the predetermined operation according to the operation instruction content notified from the voice operation instruction content recognition unit 305, and the image forming apparatus 10 executes the process on the basis of the operation (step S17).

After all the operation instructions by voice from the user are executed, the process for detecting the operation start keyword by the voice operation start keyword recognition unit 301 (step S11) is repeated until the voice operation start keyword recognition unit 301 detects the operation start keyword.

### The Flowchart of the Input Switching Process

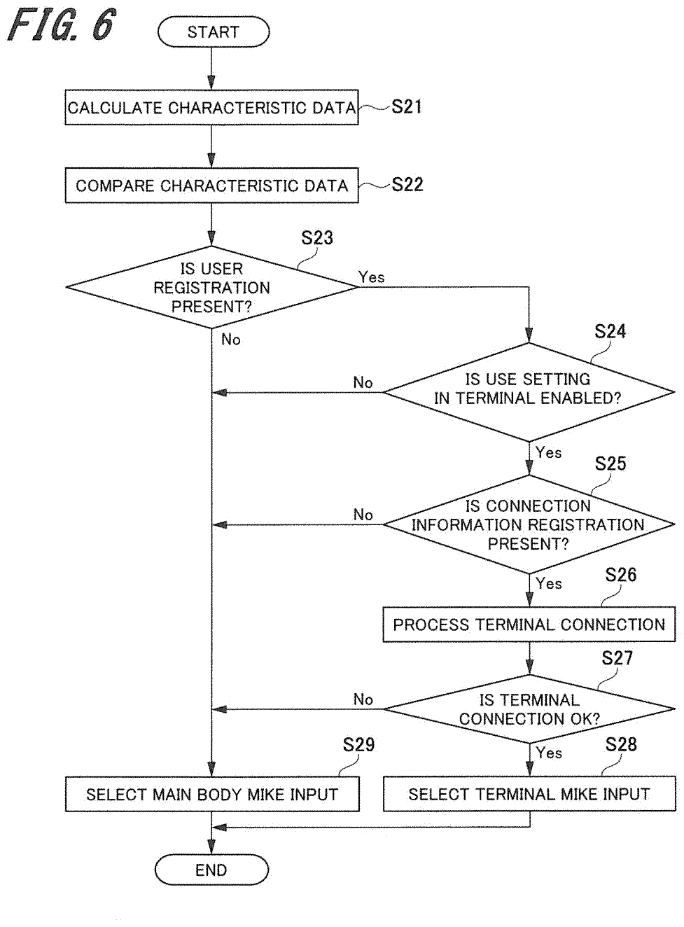

FIG. 6 illustrates the flowchart of the input switching process (step S12) in the input switching unit 303 in the operation flowchart of the voice operation of the image forming system illustrated in FIG. 5.

First, the using input determination unit 302 calculates characteristic data on the basis of the characteristic of the voice quality of the user from the first voice signal (voice data) inputted to the main body mike 150 (step S21). And, the using input determination unit 302 compares the calculated characteristic data of the first voice signal and the characteristic data included in the user information obtained from the user information management unit 304 (step S22). With this, the using input determination unit 302 searches for the user matched with the characteristic data of the first voice signal, and determines whether the user information related to the user matched with the characteristic data of the first voice signal has been registered to the user information management unit 304 (step S23).

When the user matched with the characteristic data of the first voice signal has been registered to the user information management unit 304 (Yes in step S23), the using input determination unit 302 refers to the user setting information of the portable terminal 310 from the user information registered to the user information management unit 304, and determines whether the use setting of the voice operation in the portable terminal 310 is enabled (step S24).

When the use setting of the voice operation in the portable terminal 310 of the user information is enabled (Yes in step S24), the using input determination unit 302 checks whether the connection information of the portable terminal 310, such as an IP address and a telephone number, is included in the registered user information (step S25).

When the connection information is included in the user information (Yes in step S25), the using input determination unit 302 identifies the portable terminal 310 to be communicated, and the input switching unit 303 switches the voice input unit in which the voice input is enabled, from the main body mike 150 to the portable terminal 310 (step S26). After that, the using input determination unit 302 checks the connection of the communication with the identified portable terminal 310 (step S27). And, when being able to check the connection with the portable terminal 310 (Yes in step S27), the using input determination unit 302 selects the terminal mike 311 of the portable terminal 310 as the input unit of the voice operation, and enables the voice input from the portable terminal 310 (step S28).

When the user matched with the characteristic data of the first voice signal has not been registered to the user information management unit 304 (No in step S23), when the use setting of the portable terminal 310 in the user information is not enabled (No in step S24), when the connection information is not included in the user information (No in step S25), or when the connection with the portable terminal 310 cannot be checked (No in step S27), the using input determination unit 302 selects the main body mike 150 as the input unit of the voice operation, and enables the voice input from the main body mike 150 (step S29).

After the process in step S29 or step S28, the input switching process in the input switching unit 303 in step S12 is ended.

### 2. The Embodiment of an Image Forming System (Second Embodiment)

A second embodiment of an image forming system will be described. The second embodiment can have the same configuration as the first embodiment except that the system control configuration of the image forming system is disposed in the image forming apparatus 10 and the external server 40. Thus, in the following description, only the configuration related to the system control related to the voice operation of the image forming apparatus in the image forming system will be described.

### The Configuration of the Image Forming System

As illustrated in FIG. 1, an image forming system 1A includes the image forming apparatus 10, the main body mike 150 as the configuration of the first voice input unit in which the image forming apparatus 10 receives voice input, and the external server 40, and each of them is connected by the network 20, such as a LAN (Local Area Network).

### The Configuration of the Server

The external server 40 can be achieved by a typical computer, such as a personal computer. Thus, the hardware configuration of the external server 40 can be the same as the hardware configuration of the typical computer. Thus, the detailed description of the hardware configuration of the external server 40 is omitted.

### The System Control Configuration of the Image Forming System

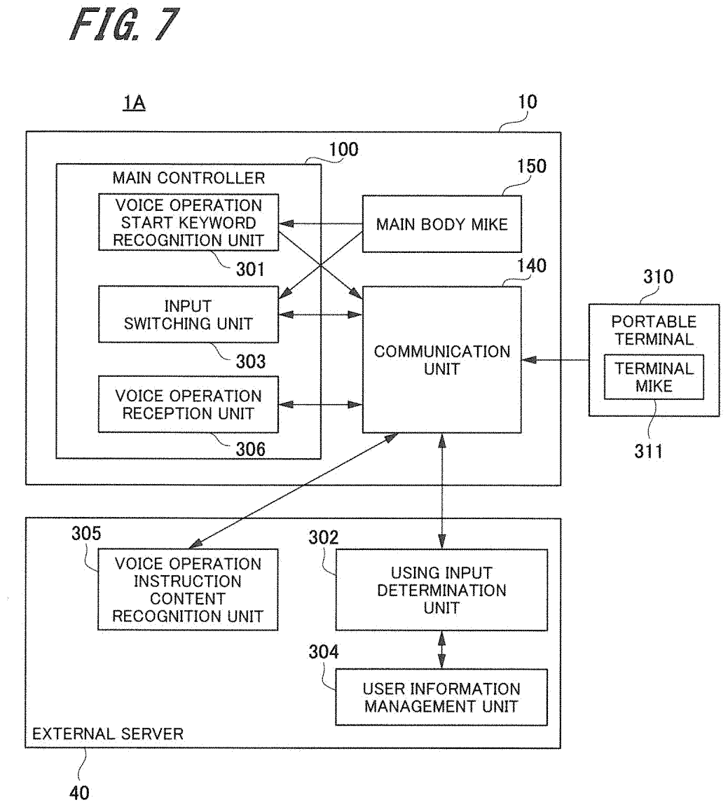

FIG. 7 illustrates the system control configuration related to the voice operation of the image forming apparatus 10 in the image forming system 1A. It should be noted that in the following description of the image forming system 1A illustrated in FIG. 7, the configuration different from the image forming system 1 illustrated in FIG. 1 will be mainly described.

The image forming system 1A includes the main body mike 150, the main controller 100, and the communication unit 140 provided in the image forming apparatus 10. Also, the image forming system 1A includes the portable terminal 310 and the external server 40 connected via the network 20 (see FIG. 1) to the communication unit 140 of the image forming apparatus 10.

The main controller 100 includes the voice operation start keyword recognition unit 301, the input switching unit 303, and the voice operation reception unit 306.

The external server 40 includes the using input determination unit 302, the user information management unit 304, and the voice operation instruction content recognition unit 305.

The portable terminal 310 includes the terminal mike 311. The portable terminal 310 is communicatively connected via the network 20 to the communication unit 140 of the image forming apparatus 10.

The voice operation starts keyword recognition unit 301 detects and recognizes a keyword meaning the start of the voice operation (a voice operation start keyword) from the first voice signal. When having recognized the keyword from the first voice signal, the voice operation starts keyword recognition unit 301 transmits the first voice signal including the voice operation start keyword via the communication unit 140 to the using input determination unit 302 of the external server 40.

The using input determination unit 302 of the external server 40 extracts, from the first voice signal, characteristic data decided on the basis of the voice quality of a user. And, the using input determination unit 302 compares the extracted characteristic data and the characteristic data of each user stored in the user information management unit 304 of the external server 40. By this comparison, the using input determination unit 302 identifies the user who utters the voice to the main body mike 150.

The using input determination unit 302 reads user information related to the identified user from the user information management unit 304, and identifies the terminal 310 to be connected, from connection information of the portable terminal 310 associated with the user information. And, the using input determination unit 302 instructs, via the communication unit 140, the input switching unit 303 of the main controller 100 to enable the connection with the identified portable terminal 310.

The input switching unit 303 of the main controller 100 switches the communication from the main body mike 150 to the portable terminal 310 identified by the using input determination unit 302, and enables the communication with the portable terminal 310. With this, the using input determination unit 302 enables the input of the voice signal from the terminal mike 311 incorporated in the portable terminal 310 (the second voice signal).

After the input switching unit 303 enables the voice input from the portable terminal 310, the voice input from the user is performed from the terminal mike 311. Thus, when the user voice inputs the voice operation start keyword to the main body mike 150, and then utters the voice operation instruction to the portable terminal 310, the second voice signal (voice data) is transmitted to the voice operation instruction content recognition unit 305 of the external server 40 via the terminal mike 311 and the communication unit 140.

The voice operation instruction content recognition unit 305 recognizes the voice of the operation instruction with respect to the image forming apparatus 10 from the second voice signal transmitted from the portable terminal 310. And, the voice operation instruction content recognition unit 305 notifies the recognized operation instruction content via the communication unit 140 to the voice operation reception unit 306 of the main controller 100. The voice operation reception unit 306 instructs the image forming apparatus 10 to execute the predetermined operation according to the operation instruction content notified from the voice operation instruction content recognition unit 305.

As described above, in the image forming systems 1 and 1A, part of the system control configuration provided in the main controller 100 of the image forming apparatus 10 according to the first embodiment may be provided in the external server connected via the network 20 to the image forming apparatus 10.

The image forming apparatus 10 includes at least the main body mike 150, the communication unit 140, the input switching unit 303, and the voice operation reception unit 306. Thus, the voice operation start keyword recognition unit 301, the using input determination unit 302, the user information management unit 304, and the voice operation instruction content recognition unit 305 are provided in one of the image forming apparatus 10 and the external server 40. Also when these configurations are provided in the external server 40, the same effect as the first embodiment can be obtained.

According to the present invention, the image forming system that can reduce the information leak risk can be provided.

It should be noted that the present invention is not limited to the configurations described in the above embodiments, and in addition, various modifications and changes can be made in the scope not departing from the configurations of the present invention.

### LIST OF REFERENCE SIGNS

1 image forming system, 10 image forming apparatus, 20 network, 30, 105 CPU, 31, 101 ROM, 32 RAM, 34 speaker, 35 touch panel, 36 network controller, 40 external server, 100 main controller, 102 HDD, 103 memory, 104 ASIC, 110 image reading unit, 120 image forming unit, 130 operation display unit, 140 communication unit, 150 main body mike, 301 voice operation start keyword recognition unit, 302 using input determination unit, 303 input switching unit, 304 user information management unit, 305 voice operation instruction content recognition unit, 306 voice operation reception unit, 310 portable terminal, 311 terminal mike

What is claimed is:

1. An image forming apparatus comprising:
a first voice input unit that collects a sound around the image forming apparatus to generate a first voice signal;
a communication unit that receives, from a portable terminal, a second voice signal generated by a second voice input unit that collects a sound around the portable terminal;
a first voice recognition unit that recognizes voice operation start voice meaning the start of a voice operation instruction on the basis of the input of the first voice signal of the first voice input unit;
a selection unit that selects the voice input unit from the first voice input unit and the second voice input unit of the portable terminal on the basis of the comparison result of the recognition result of the first voice recognition unit and previously set information;
an input switching unit that switches and enables the voice input from the first voice input unit or the second voice input unit selected by the selection unit; and
a second voice recognition unit that recognizes the content of the voice operation instruction on the basis of the first voice signal inputted from the first voice input unit in which the input switching unit enables the voice input or the second voice signal inputted from the second voice input unit in which the input switching unit enables the voice input.

2. The image forming apparatus according to claim 1,
wherein the image forming apparatus includes a management unit that manages user information related to a user who uses the image forming apparatus and the information of the portable terminal associated with the user information,
wherein the selection unit identifies the portable terminal with which the communication unit communicates, on the basis of the user information and the information of the portable terminal managed by the management unit.

3. The image forming apparatus according to claim 2,
wherein the management unit manages, as the user information, characteristic data on the basis of the characteristic of the voice quality of each user,
wherein the selection unit uses the recognition result of the first voice signal inputted from the first voice input unit and the characteristic data to identify the user who uses the image forming apparatus, and identifies the portable terminal associated with the user information.

4. The image forming apparatus according to claim 2,
wherein when the selection unit cannot identify the portable terminal to be communicated, the second voice recognition unit performs a recognition process on the basis of the input of the first voice signal inputted from the first voice input unit.

5. The image forming apparatus according to claim 2,
wherein the management unit manages, as the user information, setting information of the voice input unit used when the user performs a voice operation,
wherein when the setting information managed by the management unit includes setting in which the first voice input unit is used for the voice operation, the input switching unit enables the voice operation by the first voice input unit.

6. An image forming system that includes an image forming apparatus and an external server that can communicate with the image forming apparatus, the image forming system comprising:
a first voice input unit that collects a sound around the image forming apparatus to generate a first voice signal;
a communication unit that receives, from a portable terminal, a second voice signal generated by a second voice input unit that collects a sound around the portable terminal;
a first voice recognition unit that recognizes voice operation start voice meaning the start of a voice operation instruction on the basis of the input of the first voice signal of the first voice input unit;
a selection unit that selects the voice input unit from the first voice input unit and the second voice input unit of the portable terminal on the basis of the comparison result of the recognition result of the first voice recognition unit and previously set information;
an input switching unit that switches and enables the voice input from the first voice input unit or the second voice input unit selected by the selection unit; and
a second voice recognition unit that recognizes the content of the voice operation instruction on the basis of the first voice signal inputted from the first voice input unit in which the input switching unit enables the voice input or the second voice signal inputted from the second voice input unit in which the input switching unit enables the voice input,
wherein the first voice input unit, the communication unit, and the input switching unit are disposed in the image forming apparatus, and
wherein each of the first voice recognition unit, the selection unit, and the second voice recognition unit is disposed in at least one of the image forming apparatus and the external server.

7. The image forming system according to claim 6,
wherein the image forming system includes a management unit that manages user information related to a user who uses the image forming apparatus and the information of the portable terminal associated with the user information in at least one of the image forming apparatus and the external server,
wherein the selection unit identifies the portable terminal with which the communication unit communicates, on the basis of the user information and the information of the portable terminal managed by the management unit.

8. A controlling method of an image forming apparatus comprising:
in a first voice input unit, collecting a sound around the image forming apparatus to generate a first voice signal;
in a communication unit, receiving, from a portable terminal, a second voice signal on the basis of a sound around the portable terminal collected by a second voice input unit of the portable terminal;
in a first voice recognition unit, recognizing voice operation start voice meaning the start of a voice operation instruction on the basis of the first voice signal inputted from the first voice input unit;
in a selection unit, selecting the voice input unit from the first voice input unit and the second voice input unit of the portable terminal on the basis of the comparison result of the recognition result of the first voice recognition unit and previously set information;
in an input switching unit, enabling the voice input from the first voice input unit or the second voice input unit selected by the selection unit; and
in a second voice recognition unit, recognizing the content of the voice operation instruction with respect to the image forming apparatus on the basis of the first voice signal inputted from the first voice input unit in which the input switching unit enables the voice input or the second voice signal inputted from the second voice input unit in which the input switching unit enables the voice input.
